(19) United States
(12) Patent Application Publication
(10) Pub. No.: US 2026/0049384 A1
(43) Pub. Date: Feb. 19, 2026

(54) METAL PARTS WITH LOW COEFFICIENT OF THERMAL EXPANSION AND HIGH MECHANICAL STRENGTH

(71) Applicant: COMPAGNIE GENERALE DES ETABLISSEMENTS MICHELIN, Clermont-Ferrand (FR)

(72) Inventors: STEPHANIE VERLEENE, Clermont-Ferrand (FR); CHARLOTTE MAYER, Chamalieres (FR); PHILIPPE EGEA, Saint Georges De Mons (FR)

(21) Appl. No.: 19/102,123

(22) PCT Filed: Jul. 28, 2023
(86) PCT No.: PCT/EP2023/071003

§ 371 Date: Feb. 7, 2025

(30) Foreign Application Priority Data
Aug. 9, 2022 (FR) FR2208207

(51) Int. Cl. C22C 38/52; B22F 9/08; B22F 10/28; B22F 10/62; B22F 10/64; B33Y 10/00; B33Y 40/20; B33Y 80/00; C21D 6/00; C21D 8/00; C21D 9/00; C22C 33/04; C22C 38/00; C22C 38/02; C22C 38/04; C22C 38/48

(52) U.S. Cl. CPC C22C 38/52; B22F 9/082; B22F 10/28; B22F 10/62; B22F 10/64; B33Y 10/00; B33Y 40/20; B33Y 80/00; C21D 6/004; C21D 6/005; C21D 6/007; C21D 6/008; C21D 8/005; C21D 9/0068; C22C 33/04; C22C 38/001; C22C 38/002; C22C 38/02; C22C 38/04; C22C 38/48; B22F 2301/35; B22F 2998/10; B22F 2999/00

(57) ABSTRACT

Metal parts intended for the manufacture of rubber articles such as tires for wheels, caterpillar tracks, conveyor belts or transmission belts based on iron, in particular an Fe—Ni alloy, having a low isobaric coefficient of thermal expansion for temperatures up to about 200° C. are disclosed as well as the manufacture of such parts. The term commonly used is the coefficient of thermal expansion (CTE).

### TECHNICAL FIELD OF THE INVENTION

The present invention relates to metal parts intended for the manufacture of rubber articles such as tyres for wheels, caterpillar tracks, conveyor belts or transmission belts based on iron, in particular an Fe—Ni alloy, having a low isobaric coefficient of thermal expansion for temperatures up to about 200° C., and also to the manufacture of such parts. The term commonly used is the coefficient of thermal expansion (CTE).

### PRIOR ART

Metal parts used in the manufacture of pneumatic or non-pneumatic tyres, rubber caterpillar tracks, wheels for vehicles, i.e, with a mobility function and/or parts of pneumatic or non-pneumatic tyres, rubber caterpillar tracks or such wheels, must meet numerous requirements, notably good mechanical strength, so as not to deform during use and thus ensure an acceptable service life, and the lowest possible thermal expansion, so as to control the geometry of the rubber object formed. As a reminder, the term “pneumatic tyre” refers to a tyre that is capable of supporting a load, for example a vehicle, by means of a pressurized gas. The term “non-pneumatic tyre” refers to a tyre that is capable of supporting a load, for example a vehicle, by means other than a pressurized gas, for example by means of shrouds.

For example, a sector-type curing or vulcanization mould for vehicle wheel tyres mainly comprises two shells, each moulding one of the sidewalls of the tyre, and a plurality of sectors moulding the tread of said tyre that are movable radially between an open position and a closed position of the mould. The shells and sectors define an inner space intended to come into contact with the unvulcanized tyre blank. To form the tread pattern, strips are attached to the mould sectors and project into this inner space. For further details of a mould comprising such strips, reference may be made, for example, to EP 1 758 743 and US 2002/0139164.

These elements must not only have sufficient mechanical strength so as not to break in use and withstand the stresses associated with forming into shape the moulded materials, but must also deform as little as possible during the temperature cycles associated with the curing (or crosslinking) of these materials.

The main advantage of manufacturing by selective fusion of superimposed powder layers, more commonly known as “Powder Bed Fusion”, lies in the fact that this technique is well suited to the manufacture of small, complex-shaped components, such as mould trim strips, which are difficult to manufacture via other processes.

When selective melting is performed using a laser beam, the process is referred to as sintering, when the powder grains are partially fused, or laser melting. The laser melting technique consists in manufacturing the strip layer by layer, by stacking the powder layers consolidated and fused one on top of the other by the laser beam along a stacking direction. The term “powder” means a powder or a mixture of powders, which are mainly metallic but may also be mineral, for example ceramic.

The first layer is deposited and then fused directly on the manufacturing plate. The other layers are then formed in succession so as to obtain a stack from the first layer.

Generally, the manufacture of a small element, such as a trim strip, is performed horizontally on the manufacturing plate, so that its length is substantially parallel to the manufacturing plate. This is referred to as horizontal manufacturing. This avoids having an excessive strip height, thus reducing the manufacturing time. Such elements must have good breaking and/or fatigue strength properties so as to ensure a long service life, hence the importance of the alloy used in such manufacturing.

Fe—Ni alloys of composition generally of the 64Fe-36Ni type having low coefficients of thermal expansion for temperatures up to about 200° C., are already known in the prior art. They are generally sold under the name INVARR 36. However, it would be advantageous to improve the mechanical strength and hardness of such an alloy while at the same time keeping the coefficient of thermal expansion (CTE) as low as possible, and allowing them to be used by additive manufacturing.

It is already known practice to improve the mechanical strength of INVAR® 36 by reinforcing the alloy via the precipitation of multiple carbides and by strong deformation, in particular when cold.

This is thus the case with patent application WO 03/025239, which proposes reinforcement with Ti. Nb. V. Mo. Hf and Ta carbides and the production of a very highly cold-deformed wire. The authors thus obtain a tensile strength Rm of up to 1300 MPa for a CTE of 3.7×10⁻⁶/° C. between 2° and 230° C. However, the alloys thus obtained cannot be used by additive manufacturing because their carbon content is too high and the presence of carbides thus hampers said additive manufacturing.

This is also the case with patent application RU 2568541, which also proposes reinforcement with carbides of Nb. Ti. V. Mo. W and Zr in large amount. The authors thus obtain a tensile strength Rm of up to 1900 MPa for a CTE <7×10⁻⁶/° C. between-196 and 327° C., after forging and heat treatment. However, the alloys thus obtained cannot be used by additive manufacturing due to the presence of cobalt, which should be removed from the powder for health and safety reasons, in a content of not more than 0.5% by weight.

Nakama et al. (Metallogr. Microstruct. Anal. 2, 383-387 (2013)) also propose reinforcement by precipitation of V or Ti or Zr or Nb or Ta carbides. The authors obtain a tensile strength Rm of up to 1010 MPa for a CTE of 2.5×10⁻⁶/° C. between 5° and 150° C., after forging and heat treatment. However, the alloys thus obtained cannot be used by additive manufacturing because their carbon content is too high and the presence of carbides thus hampers said additive manufacturing.

The inventors realised, surprisingly, that it was possible to improve the mechanical strength of mechanical parts while at the same time maintaining a CTE as low as possible and allowing them to be manufactured by additive manufacturing. They thus realised that to achieve such a result (Rm-CTE compromise) it was necessary to perform hardening by precipitation of the γ″ (gamma second) phase of the alloy while at the same time adjusting the Nb and Ni elements. Specifically, a fine intragranular precipitation is thus obtained which disturbs the magnetic ordering less than large precipitates and thus increases the CTE less. It is also possible to simplify the heat treatment subsequent to additive manufacturing by not having to perform dissolution at a very high temperature to obtain the desired hardening. Moreover, all the additional Nb and Ni elements are found in the precipitates, without any remaining in solid solution in the austenite, which would be detrimental to the CTE, and 36% Ni remains in substitution in the austenite after precipitation of all the γ″ (gamma second) phase possible so as to be in optimum CTE condition. Carbon is also added to the composition in order to form a few NbC carbides, allowing austenite grain growth to be limited during heat treatment. However, the carbon content is limited so that it can be used by additive manufacturing.

### DETAILED DESCRIPTION OF THE INVENTION

The invention relates to a metal part for manufacturing rubber articles based on an iron-based alloy composition comprising, advantageously consisting essentially of, in percentages by weight of the total composition:
Nickel: 38.0-42.0, advantageously 39.0-42.0;
Niobium: 4.750-5.500, advantageously 5.000-5.500;
Carbon: 0.010-0.100, advantageously 0.015-0.070;
Cobalt: ≤0.400, advantageously≤0.100;
Chromium: ≤0.500;
Silicon: ≤0.500;
Manganese: ≤0.500;
Iron: remainder;
and also the inevitable impurities.

The invention also relates to a process for manufacturing such a metal part, comprising the following steps:
A—manufacturing an iron-based alloy powder having the composition of the alloy composition on which the metal part according to the invention is based, according to the following steps:
a) mixing elementary or pre-alloyed starting materials,
b) melting the mixture obtained in step a), advantageously in a vacuum induction muffle furnace,
c) gas atomization, advantageously with nitrogen, of the product obtained in step b) so as to obtain a powder,
d) screening or sieving the powder obtained in step c) so as to obtain a desired particle size fraction,
e) recovering the powder obtained.
B1—subjecting the powder obtained in step A) to an additive manufacturing process, advantageously chosen from the group consisting of selective laser melting on a powder bed (LBM), electron beam melting (EBM), laser melting by powder spraying such as Direct Additive Laser Construction or Direct Metal Deposition (DMD) and injection of binder on a powder bed (MBJ), or to a hot isostatic compaction treatment with the objective of obtaining a part or
B2—subjecting the powder obtained in step A) to a laser melting process by powder spraying, such as Direct Additive Laser Construction or Direct Metal Deposition (DMD), followed by forging of the deposit formed from the melted powder,
C—subjecting the part obtained in step B1) or B2) to at least one thermal and/or physical and/or chemical treatment, advantageously chosen from the group consisting of a relaxation heat treatment, a hot isostatic compaction treatment if step B1) is not a hot isostatic compaction treatment, a dissolution treatment, an ageing treatment, a finishing treatment such as a surface modification treatment or deposition of a coating to protect against corrosion and oxidation, and a mixture of these treatments,
D—recovering the part thus obtained.

The invention also relates to a process for manufacturing such a metal part, comprising the following steps:
i, mixing elementary or pre-alloyed starting materials.
ii, melting the mixture obtained in step i), advantageously in a vacuum induction muffle furnace.
iii, optionally, homogenization by heat treatment of the ingot obtained in step ii).
iv, transforming the ingot obtained in either of steps ii) and iii) by forging,
v. recovering the part thus obtained,
vi, preferentially, subjecting the part obtained in step v) to at least one thermal and/or physical and/or chemical treatment, advantageously chosen from the group consisting of a relaxation heat treatment, a hot isostatic compaction treatment, a dissolution treatment, an ageing treatment, a finishing treatment such as a surface modification treatment or deposition of a coating to protect against corrosion and oxidation, and a mixture of these treatments.

The invention also relates to a metal part obtained via one of these processes, and also to the use of a metal part according to the invention or obtained via a process according to the invention for manufacturing pneumatic or non-pneumatic tyres, rubber caterpillar tracks, wheels for vehicles, i.e. having a mobility function, and/or parts of pneumatic or non-pneumatic tyres, rubber caterpillar tracks or such wheels.

### Definitions

In the present text, unless expressly indicated otherwise, all the percentages (%) indicated are mass percentages (%).

The expression “composition based on” should be understood as meaning a composition including the mixture and/or the product of the in situ reaction of the various constituents used, some of these constituents being able to react and/or being intended to react with each other, at least partially, during the various phases of manufacture of the composition. In the more specific case of a rubber composition, the composition may thus be in the totally or partially crosslinked state or in the non-crosslinked state.

The compounds comprising carbon mentioned in the description may be of fossil or biobased origin. In the latter case, they may be partially or totally derived from biomass or may be obtained from renewable starting materials derived from biomass. Polymers, plasticizers, fillers, and the like, are notably concerned.

### Metal Part

The present invention thus relates to a metal part for manufacturing rubber articles based on an iron-based alloy composition comprising, advantageously consisting essentially of, in particular consisting of, in percentages by weight of the total composition:
Nickel: 38.0-42.0, advantageously 39.0-42.0;
Niobium: 4.750-5.500, advantageously 5.000-5.500;
Carbon: 0.010-0.100, advantageously 0.015-0.070;
Cobalt: ≤0.400, advantageously≤0.100;
Chromium: ≤0.500;
Silicon: ≤0.500;
Manganese: ≤0.500;
Iron: remainder;
and also the inevitable impurities.

A metal part for manufacturing rubber articles based on a particularly advantageous iron-based alloy composition according to the invention comprises, advantageously consists essentially of, in particular consists of, in percentages by weight of the total composition:
Nickel: 39.0-42.0;
Niobium: 5.000-5.500;
Carbon: 0.015-0.070;
Cobalt: ≤0.050;
Chromium: ≤0.100;
Silicon: ≤0.500;
Manganese: ≤0.500;
Iron: remainder;
and also the inevitable impurities.

In the context of the present invention, the ranges “X-Y %” and “X to Y” mean that the limits X and Y are included. The range “between X and Y” excludes the limits X and Y.

In the context of the present invention, the measurement uncertainties indicated are typical uncertainties.

In particular, the inevitable impurities, notably chosen from nitrogen (N), oxygen (O), hydrogen (H), sulfur(S), phosphorus (P), aluminium (Al), titanium (Ti), vanadium (V), molybdenum (Mo), calcium (Ca), copper (Cu), magnesium (Mg) and mixtures thereof, are kept as low as possible. These impurities are generally due essentially to the manufacturing process and the quality of the furnace charging. Advantageously, the alloy composition on which the metal part according to the invention is based comprises not more than 1.00% by weight of inevitable impurities, advantageously not more than 0.75% by weight, even more advantageously not more than 0.50% by weight, relative to the total weight of the composition. Generally speaking, the content of impurities in the alloy is measured with an absolute uncertainty of ±0.08%.

In particular, the alloy composition on which the metal part according to the invention is based comprises in percentages by weight of the total composition:
Nitrogen≤0.030, advantageously≤0.020, in particular≤0.010, and/or
Oxygen≤0.040, advantageously≤0.035.

Limiting the nitrogen content makes it possible to limit the formation of nitrides in the alloy, which could be detrimental to the CTE. The nitrogen content is measured with an absolute uncertainty of ±0.0012%.

Limiting the oxygen content makes it possible to limit the formation of oxides that could be detrimental to the CTE and to the ductility of the alloy. Oxygen contents of this magnitude may appear surprising by comparison with conventional processes, but fractioning the metal in the form of a powder results in a very high surface area/volume ratio, which will tend to greatly increase the oxygen content of the alloy. This will increase further if the powder manufacturing process is not sufficiently controlled. The oxygen content is measured with an absolute uncertainty of ±0.0019%.

Advantageously, the hydrogen content of the alloy composition on which the metal part according to the invention is based is ≤0.0050% by weight relative to the total weight. Limiting the hydrogen content allows the embrittlement of the alloy to be limited. The hydrogen content is measured with an absolute uncertainty of ±0.0005%.

Advantageously the sulfur content of the alloy composition on which the metal part according to the invention is based is ≤0.0150% by weight of the total composition, advantageously≤0.0050% by weight of the total composition. Limiting the sulfur content makes it possible to limit the formation of low-melting phases such as FeS, which would wet the grain joints, which is detrimental to the alloy. Specifically, these phases have very low mechanical strength and their presence would thus reduce the alloy's mechanical characteristics. The sulfur content is measured with an absolute uncertainty of ±0.0001%.

Advantageously, the phosphorus content of the alloy composition on which the metal part according to the invention is based is ≤0.0150% by weight of the total composition, advantageously≤0.0050% by weight of the total composition. Limiting the phosphorus content makes it possible to limit the formation of low-melting phases such as FesP which would accumulate in the grain joints and thus be harmful to the alloy by reducing its resilience. The phosphorus content is measured with an absolute uncertainty of ±0.0001%.

Advantageously, the aluminium content of the alloy composition on which the metal part according to the invention is based is ≤0.100% by weight of the total composition. Limiting the aluminium content makes it possible to limit the formation of any intermetallic phases between Ni and Al, for instance the γ′ (gamma prime) phase, which would result in the formation of precipitates potentially larger than the γ″ (gamma second) precipitates and which would reduce the Ni content in the austenite. This would consequently cause an increase in the CTE. The aluminium content is measured with an absolute uncertainty of ±0.005%.

Advantageously, the titanium content of the alloy composition on which the metal part according to the invention is based is ≤0.100% by weight of the total composition. Limiting the titanium content makes it possible to limit the formation of any intermetallic phases between Ni and Ti, for instance the γ′ (gamma prime) phase or the n (eta) phase, which would result in the formation of precipitates potentially larger than the γ″ (gamma second) precipitates and which would reduce the Ni content in the austenite. This would consequently cause an increase in the CTE. The titanium content is measured with an absolute uncertainty of ±0.005%.

Advantageously the vanadium content of the alloy composition on which the metal part according to the invention is based is ≤0.100% by weight of the total composition. Limiting the vanadium content makes it possible to limit the formation of coarse vanadium carbides which would have a detrimental impact on the CTE. The vanadium content is measured with an absolute uncertainty of ±0.007%.

Advantageously the molybdenum content of the alloy composition on which the metal part according to the invention is based is ≤0.020% by weight of the total composition. Limiting the molybdenum content makes it possible to limit the formation of coarse molybdenum carbides which would have a detrimental impact on the CTE. The molybdenum content is measured with an absolute uncertainty of ±0.003%.

Advantageously the calcium content of the alloy composition on which the metal part according to the invention is based is ≤0.015% by weight of the total composition. Limiting the calcium content makes it possible to limit the formation of inclusions that are detrimental to the alloy. The calcium content is measured with an absolute uncertainty of ±0.005%.

Advantageously the copper content of the alloy composition on which the metal part according to the invention is based is ≤0.010% by weight of the total composition. Limiting the copper content makes it possible to limit the formation of copper precipitates in the grain joints, which might be detrimental to the CTE and to the mechanical properties of the alloy. The copper content is measured with an absolute uncertainty of ±0.002%.

Advantageously the magnesium content of the alloy composition on which the metal part according to the invention is based is ≤0.015% by weight of the total composition. Limiting the magnesium content makes it possible to limit the formation of inclusions that are detrimental to the alloy. The magnesium content is measured with an absolute uncertainty of ±0.005%.

Preferably, the alloy composition on which the metal part according to the invention is based has a content of an inevitable impurity chosen from nitrogen (N), oxygen (O), hydrogen (H), sulfur(S), phosphorus (P), aluminium (Al), titanium (Ti), vanadium (V), molybdenum (Mo), calcium (Ca), copper (Cu), magnesium (Mg) and mixtures thereof meeting at least one, preferably at least two, more preferably at least three and most preferably all of the following conditions:
nitrogen≤0.030% by weight of the total composition:
oxygen≤0.040% by weight of the total composition:
hydrogen≤0.0050% by weight of the total composition:
sulfur≤0.0150% by weight of the total composition:
phosphorus≤0.0150% by weight of the total composition:
aluminium≤0.100% by weight of the total composition;
titanium≤0.100% by weight of the total composition:
vanadium≤0.100% by weight of the total composition:
molybdenum≤0.020% by weight of the total composition:
calcium≤0.015% by weight of the total composition:
copper≤0.010% by weight of the total composition:
magnesium≤0.015% by weight of the total composition.

The alloy composition on which the metal part according to the invention is based thus comprises nickel (Ni) in a weight percentage content relative to the total weight of the composition in the range 38.0-42.0, advantageously 39.0-42.0, even more advantageously 39.5-42.0. Specifically, nickel plays two roles in the alloy: the first is to give the alloy its invar character, i.e. low CTE up to about 200° C., and the second is to participate in the hardening of the alloy by the formation of γ″ (gamma second) or 8 (delta) precipitates, both of Ni₃Nb composition. The minimum nickel content of 38.0% is required for 36% Ni substitution to remain in the austenite after precipitation of all the γ″ (gamma second) phase possible, so as to be in the optimum CTE condition. It is not desirable for the Ni content to exceed 42%, since there could then be too much Ni substitution in the matrix, which would be detrimental to the CTE. The nickel content is measured with an absolute uncertainty of ±0.3%.

The alloy composition on which the metal part according to the invention is based also comprises niobium (Nb) in a weight percentage content relative to the total weight of the composition in the range 4.750-5.500, advantageously 5.000-5.500, even more advantageously 5.100-5.300. Specifically, niobium mainly allows the formation of small precipitates of the hardening phase γ″ (gamma second) intergranularly, which is very compatible with additive manufacturing in that it does not give rise to cracking problems, and with the desired application because it does not greatly increase the CTE. Niobium also allows the formation of a small fraction of Nb carbides, enabling the grain to be held together during heat treatment, notably during dissolution. It is necessary to have an Nb content of greater than 4.750 to obtain the desired reinforcement. On the other hand, it is not desirable to go above 5.500 as this would degrade the CTE too much and could lead to the precipitation of undesirable phases. The niobium content is measured with an absolute uncertainty of ±0.005%.

The alloy composition on which the metal part according to the invention is based also comprises carbon (C) in a weight percentage content relative to the total weight of the composition in the range 0.010-0.100, advantageously 0.015-0.070, even more advantageously 0.015-0.050. Specifically, carbon allows the precipitation of Nb carbides at high temperature, which play a role in blocking grain growth during the heat treatment, in particular during dissolution. In order to obtain high hardening and high yield strength, it is necessary to control the grain growth. It is necessary to have a carbon content of less than 0.100 to allow additive manufacturing to be performed. At this content, the carbon is in the precipitates, without remaining in solid solution in the austenite, which would be detrimental to the CTE. The carbon content is measured with an absolute uncertainty of ±0.0015%.

The cobalt (Co) content of the alloy composition on which the metal part according to the invention is based is ≤0.400% by weight relative to the total weight of the composition, advantageously≤0.100% by weight relative to the total weight of the composition, more advantageously≤0.050% by weight relative to the total weight of the composition. Specifically, the cobalt content must be as low as possible because cobalt poses HSE (Health, Safety, Environment) problems when handling the powders for manufacture by additive manufacturing. In an advantageous embodiment, the alloy composition on which the metal part is based comprises cobalt only as an inevitable impurity. The term “comprises cobalt only as an inevitable impurity” means that the cobalt content is as low as possible, and preferably less than or equal to the measurement tolerance. The alloy composition on which the metal part according to the invention is based may thus be said to be “free” of cobalt. The cobalt content is measured with an absolute uncertainty of ±0.003%.

The chromium (Cr) content of the alloy composition on which the metal part according to the invention is based is ≤0.500% by weight relative to the total weight of the composition, advantageously≤0.100% by weight relative to the total weight of the composition. Specifically, the chromium content must be as low as possible since chromium may form carbides during the heat treatment or become a solid substitution in the austenite, which would be detrimental to the CTE. The chromium content is measured with an absolute uncertainty of ±0.0015%.

The silicon (Si) content of the alloy composition on which the metal part according to the invention is based is ≤0.500% by weight relative to the total weight of the composition, advantageously≤0.470% by weight relative to the total weight of the composition. Specifically, the silicon content must be as low as possible since this element is known to segregate in the liquid, resulting either in the formation of oxides or in the formation of low-melting phases which pose problems for use by additive manufacturing, such as cracking. The silicon content is measured with an absolute uncertainty of ±0.0063%.

The manganese (Mn) content of the alloy composition on which the metal part according to the invention is based is ≤0.500% by weight relative to the total weight of the composition, advantageously≤0.400% by weight relative to the total weight of the composition. Specifically, the manganese content must be as low as possible since this element may induce the formation of oxides or carbides that are detrimental to the CTE. The manganese content is measured with an absolute uncertainty of ±0.009%.

In particular, the alloy composition on which the metal part according to the present invention is based may be chosen from one of the two examples shown in tables 1 and 3 of the example section below.

The metal part according to the invention may be manufactured from an iron-based alloy composition in the form of a powder, a forged part, a rolled part or a wire, advantageously a powder, in particular intended for additive manufacturing, or a forged part.

In an advantageous embodiment, the metal part according to the invention may be manufactured from an alloy composition in the form of a wire, used as such or in the form of cables formed from the wire or intended for forming into shape by wire deposition, according to the various possible processes (by arc, plasma, electron beam or laser).

In another advantageous embodiment, the metal part according to the invention may be manufactured from an alloy composition in the form of a powder, intended for forming into shape by additive manufacturing, advantageously chosen from the group consisting of selective laser melting on a powder bed (LBM), electron beam melting (EBM), laser melting by powder spraying such as Direct Additive Laser Construction (CLAD®) or Direct Metal Deposition (DMD) and metal binder jetting (MBJ), more particularly selective laser melting on a powder bed (LBM).

The powder on which the metal part according to the invention is preferentially based has a particle size distribution (number diameter) in the range 10 to 60 μm, in particular if it is intended for manufacturing the part by selective laser melting on a powder bed (LBM). Traditionally for this type of particle size cut, the lower limit of 10 μm, characterized by the D10 by number, is controlled by laser diffraction (ASTM B822-17), and the upper cut characterized by the D90 by number of 60 μm is controlled by screening. The practice of particle size cut control according to the standard ASTM B214-16 or ISO 2591-1 of 1988 in force allows cuts of up to 45 μm to be controlled by screening. Below this limit, control by screening is no longer permitted according to the standard and characterization is done by the D10 value by number of the distribution measured by laser diffraction.

The metal part according to the invention is preferentially chosen from curing moulds, injection moulds and the constituent elements of these moulds. Specifically, its mechanical properties make it particularly suitable for these uses, which are subject to numerous heating/cooling cycles.

### Manufacturing Process

The present invention also relates to a process for manufacturing a metal part for the manufacture of rubber articles according to the invention in an iron-based alloy, comprising the following steps:
A—manufacturing an iron-based alloy powder having the composition of the alloy composition on which the metal part according to the invention is based, advantageously by means of the following process:
a—mixing elementary or pre-alloyed starting materials,
b—melting the mixture obtained in step a), advantageously in a vacuum induction muffle (VIM) furnace.
c—gas atomization, advantageously with nitrogen, of the product obtained in step b) so as to obtain a powder, which is advantageously predominantly spherical (i.e, without any sharp angles),
d—screening or sieving the powder obtained in step c), advantageously under an inert atmosphere, so as to obtain a desired particle size fraction,
e—recovering the powder obtained.

The particle size of the powder is thus adapted as a function of the additive manufacturing technology or powder deposition process envisaged. The particle size ranges used for the various additive manufacturing or powder deposition processes vary as a function of the technology, equipment and intended applications. In general, if all the applications are combined, the powder used for these processes will have more or less broad particle size distributions between 5 and 150 μm by number (as indicated above, the lower limit of 5 μm, characterized by the D10 by number, is controlled by laser diffraction (ASTM B822-17), and the upper cut of 150 μm, characterized by the D90 by number, is controlled by screening).
B1—subjecting the powder obtained in step A) to an additive manufacturing process, advantageously chosen from the group consisting of selective laser melting on a powder bed (LBM), electron beam melting (EBM), laser melting by powder spraying such as Direct Additive Laser Construction (CLAD®) or Direct Metal Deposition (DMD) and injection of binder on a powder bed (MBJ), or to a hot isostatic compaction (HIC) treatment with the objective of obtaining a part or
B2—subjecting the powder obtained in step A) to a laser melting process by powder spraying, such as Direct Additive Laser Construction (CLAD®) or Direct Metal Deposition (DMD), followed by forging of the deposit formed from the melted powder.
C—subjecting the part obtained in step B1) or B2) to at least one thermal and/or physical and/or chemical treatment, advantageously chosen from the group consisting of a relaxation heat treatment, a hot isostatic compaction (HIC) treatment if step B1) is not a hot isostatic compaction (HIC) treatment, a dissolution treatment, an ageing treatment, a finishing treatment such as a surface modification treatment or deposition of a coating to protect against corrosion and oxidation, and a mixture of these treatments.
D—recovering the part thus obtained.

The additive manufacturing process that may be used in the context of the present invention, in particular such as selective laser melting on a powder bed (LBM), electron beam melting (EBM), laser melting by powder spraying such as Direct Additive Laser Construction (CLAD®) or Direct Metal Deposition (DMD) and injection of binder on a powder bed (MBJ), are well known to those skilled in the art.

In an advantageous embodiment, step B1) consists of an additive manufacturing process which comprises the layer-by-layer manufacture of the part using an energy source (laser or electron beam) which melts a thin layer of the superalloy powder according to the invention. A second layer of superalloy powder according to the invention is then deposited and then melted. This process is repeated until the final part is obtained. Advantageously, this is selective laser melting on a powder bed (LBM).

In an advantageous embodiment, step C) of the process of the invention consists of a dissolution treatment between 1050° C., and 1150° C., advantageously between 1050° C., and 1100° C., in particular 1050° C., for 1 hour to 4 hours, advantageously for 1 hour, followed by an ageing treatment between 600° C., and 700° C., advantageously between 600° C., and 650° C., in particular 600° C., for 5 hours to 10 hours, advantageously for 5 hours, or of a direct ageing treatment between 600° C., and 700° C., advantageously between 600° C., and 650° C., in particular 600° C., for 5 hours to 10 hours, advantageously for 5 hours, without dissolution. Such treatment conditions allow the hardness of the metal part to be maximized.

In a particularly advantageous embodiment, step C) of the process according to the invention consists of a direct ageing treatment between 600° C., and 700° C., advantageously between 60° and 650° C., in particular 600° C., for 5 hours to 10 hours, advantageously for 5 hours, without dissolution. Such treatment conditions allow the hardness of the metal part to be maximized if it is not desired to perform a high-temperature heat treatment.

In another advantageous embodiment, step C) of the process according to the invention consists of a dissolution treatment between 900° C., and 1000° C., advantageously between 900° C., and 950° C., in particular 950° C., for 30 minutes to 1 hour, followed by an ageing treatment between 600° C., and 700° C., advantageously between 600° C., and 650° C., in particular 600° C., for 5 hours to 10 hours, advantageously for 5 hours. Such treatment conditions allow the elongation at break of the metal part to be maximized.

The present invention further relates to a metal part manufacturing process for manufacturing iron-based alloy rubber articles according to the invention, comprising the following steps:
i—mixing elementary or pre-alloyed starting materials.
ii—melting the mixture obtained in step i), advantageously in a vacuum induction muffle (VIM) furnace,
iii—optionally, homogenization by heat treatment of the ingot obtained in step ii), advantageously at a temperature of 1240° C., for 4 hours.
iv—transforming the ingot obtained in either of steps ii) or iii) by forging, in particular at elevated temperature, advantageously with a degree of deformation of 80% to 90%,
v—recovering the metal part thus obtained.

In an advantageous embodiment, the process according to the invention comprises an additional step vi) of subjecting the part obtained in step v) to at least one thermal and/or physical and/or chemical treatment, advantageously chosen from the group consisting of a relaxation heat treatment, a hot isostatic compaction treatment, a dissolution treatment, an ageing treatment, a finishing treatment such as a surface modification treatment or deposition of a coating to protect against corrosion and oxidation, and a mixture of these treatments.

In an advantageous embodiment, step vi) of the process of the invention consists of a dissolution treatment between 1050° C., and 1150° C., advantageously between 1050° C., and 1100° C., in particular 1050° C., for 1 hour to 4 hours, advantageously for 1 hour, followed by an ageing treatment between 600° C., and 700° C., advantageously between 600° C., and 650° C., in particular 600° C., for 5 hours to 10 hours, advantageously for 5 hours, or of a direct ageing treatment between 600° C., and 700° C., advantageously between 600° C., and 650° C., in particular 600° C., for 5 hours to 10 hours, advantageously for 5 hours, without dissolution. Such treatment conditions allow the hardness of the metal part to be maximized.

In a particularly advantageous embodiment, step vi) of the process according to the invention consists of a direct ageing treatment between 600° C., and 700° C., advantageously between 60° and 650° C., in particular 600° C., for 5 hours to 10 hours, advantageously for 5 hours, without dissolution. Such treatment conditions allow the hardness of the metal part to be maximized if it is not desired to perform a high-temperature heat treatment.

In another advantageous embodiment, step vi) of the process according to the invention consists of a dissolution treatment between 900° C., and 1000° C., advantageously between 900° C., and 950° C., in particular 950° C., for 30 minutes to 1 hour, followed by an ageing treatment between 600° C., and 700° C., advantageously between 600° C., and 650° C., in particular 600° C., for 5 hours to 10 hours, advantageously for 5 hours. Such treatment conditions allow the elongation at break of the metal part to be maximized.

The present invention also relates to a metal part for manufacturing rubber articles according to the invention from an iron-based alloy obtained from an alloy powder, which may advantageously be obtained via the process of the invention.

Advantageously, the metal part according to the invention is characterized in that:
its coefficient of linear expansion is less than 3.5×10⁻⁶/° C., advantageously less than 3.4×10⁻⁶/° C., more advantageously≤3.3×10⁻⁶/° C. between 30° C., and 200° C., according to the standard ASTM E228-17 (2017) and/or
it has a tensile strength of greater than 1000 MPa, advantageously greater than or equal to 1100 MPa according to the standard ISO6892-1 (2019) and/or
it has a hardness HV30 of greater than 350 HV, in particular greater than 360 HV, more particularly greater than 370 HV, even more particularly greater than 375 HV, according to the standard ISO 6507-1 (2018).

The present invention finally relates to the use of a metal part according to the invention or obtained via one of the processes according to the invention, for manufacturing pneumatic or non-pneumatic tyres, rubber caterpillar tracks, wheels for vehicles, i.e. having a mobility function, and/or parts of pneumatic or non-pneumatic tyres, rubber caterpillar tracks or such wheels.

The present invention will be understood more clearly on reading the description of the examples that follow, which are given as non-limiting guides.

In the examples, unless otherwise mentioned, all the percentages are given on a weight basis, the temperature is in degrees Celsius, and the pressure is atmospheric pressure.

The metal compositions are determined by measuring the infrared absorption and thermal conductivity of the combustion gases (LECO) and by inductively coupled plasma (ICP) mass spectrometry.

### Examples

Various metal parts consisting of the iron-based alloys whose compositions are indicated in Tables 1 and 3 are manufactured. The property measurements are listed in Tables 2 and 4.

Table 1 shows an example 1 of an iron-based alloy for a metal part according to the present invention, reinforced by γ″ (gamma second) phase precipitation in a proportion capable of correctly hardening the alloy. A standard Invar 36 type alloy, without hardening elements, with the same levels of residuals was produced as a reference, along with four counter-example alloys.

Counter-example 1 is an iron-based alloy reinforced with the γ″ (gamma second) phase in a content lower than that of the alloy of a part according to the invention (the Nb content is less than 4.75 as a weight percentage of the total composition).

Counter-example 2 is an iron-based alloy reinforced by the precipitation of molybdenum carbides, with an Mo content of 3.97 as a weight percentage and a C content of 0.236 as a weight percentage.

Counter-example 3 is an iron-based alloy reinforced by the precipitation of molybdenum and niobium carbides, with contents in weight percentages of 3.95 of Mo. 0.475 of Nb and 0.212 of C. These Mo. Nb and C contents are within the windows claimed by patent application WO 03/025239 with an Mo content of 1.5 to 6, an Nb content of less than or equal to 0.5 and a C content of 0.2 to 0.4.

Counter-example 4 is an iron-based alloy reinforced by the precipitation of vanadium carbides, with a V content of 0.899 and a C content of 0.204. These V and C contents are very close to those of Invar-V in the publication by Nakama et al. (Metallogr. Microstruct. Anal. (2 (2013) 383-387), with a V content of 0.8 and a C content of 0.203.

TABLE 1

| | | Reference | Counter- | Counter- | Counter- | Counter- |
|---|---|---|---|---|---|---|
| Elements | Example 1 | Invar 36 | example 1 | example 2 | example 3 | example 4 |
| Fe + | remainder | remainder | remainder | remainder | remainder | remainder |
| impurities | | | | | | |
| Ni | 40.2 ± 0.3 | 36.1 ± 0.3 | 38.1 ± 0.2 | 35.6 ± 0.2 | 35.5 ± 0.3 | 35.7 ± 0.3 |
| Co | <0.400 | <0.5 | <0.5 | <0.5 | <0.5 | <0.5 |
| Cr | <0.100 | <0.1 | <0.1 | <0.1 | <0.1 | <0.1 |
| Nb | 5.190 ± | — | 2.810 ± | — | 0.475 ± | — |
| | 0.005 | | 0.005 | | 0.004 | |
| V | — | — | — | — | — | 0.899 ± |
| | | | | | | 0.005 |
| Mo | — | — | — | 3.97 ± | 3.95 ± | — |
| | | | | 0.02 | 0.03 | |
| C | 0.042 ± | 0.035 ± | 0.035 ± | 0.236 ± | 0.212 ± | 0.204 ± |
| | 0.0016 | 0.0012 | 0.0014 | 0.0026 | 0.0016 | 0.0021 |
| N | 0.0084 ± | 0.0046 ± | 0.007 ± | 0.0043 ± | 0.0077 ± | 0.0047 ± |
| | 0.0012 | 0.0008 | 0.0014 | 0.0009 | 0.0010 | 0.0009 |
| O | 0.0015 ± | 0.002 ± | 0.0016 ± | 0.002 ± | 0.003 ± | 0.00087 ± |
| | 0.0005 | 0.0008 | 0.0005 | 0.0009 | 0.0003 | 0.0003 |
| Mn | 0.027 ± | 0.028 ± | 0.021 ± | 0.03 ± | 0.029 ± | 0.035 ± |
| | 0.005 | 0.005 | 0.005 | 0.005 | 0.005 | 0.005 |
| Si | 0.464 ± | 0.396 ± | 0.478 ± | 0.47 ± | 0.463 ± | 0.482 ± |
| | 0.005 | 0.043 | 0.005 | 0.005 | 0.0047 | 0.005 |
| S | 0.00024 ± | 0.00049 ± | 0.00042 ± | 0.0004 ± | 0.00042 ± | 0.00067 ± |
| | 0.00010 | 0.00010 | 0.00010 | 0.00010 | 0.00010 | 0.00010 |
| P | <0.0050 | <0.005 | <0.005 | <0.005 | <0.005 | <0.005 |

Table 2 shows the results for maximum mechanical strength, Rm (according to the standard ISO 6892-1:2019) at room temperature, Vickers hardness HV30 (according to the standard ISO 6507-1:2018) at room temperature, and coefficient of thermal expansion between 3° and 200° C. (CTE) measured according to the standard ASTM E228-17 (2017) for Example 1, Invar 36 reference and the four counter-examples after the following implementation: production of 6 kg ingots in a vacuum muffle furnace (VIM), homogenization at 1240° C., for 4 hours, hot forging by punch drawing with a degree of deformation of between 80% and 90% followed by air cooling and heat treatment. The final heat treatment is different for each alloy, and the results reported are the best obtained. Example 1 underwent ageing at 600° C., for 5 h followed by air cooling, counter-examples 1, 2 and 3 underwent precipitation ageing at 650° C., for 5 h followed by air cooling, the Invar 36 reference alloy underwent treatment at 1100° C., for 1 h followed by water cooling, and counter-example 4 underwent dissolution at 1250° C., for 1 h followed by water cooling and ageing at 650° C., for 5 h followed by air cooling.

The γ″ (gamma second) phase precipitation reinforcement strategy used to reinforce the alloy allows the best hardening to be obtained for a limited increase in CTE, compared with the reference Invar 36 and the four counter-examples produced with the same levels of residuals and for an equivalent transformation range. Furthermore, the low hardness level of counter-example 1, with an Nb content of 2.81, shows that it is necessary to have an Nb content of greater than 4.75 to obtain the desired reinforcement. On the other hand, it is not desirable to go above 5.5 as this would degrade the CTE too much and could lead to the precipitation of undesirable phases.

Moreover, these results show the strong influence of the transformation range, and in particular the cold spinning or drawing steps, on hardening. Specifically, counter-example 3, whose Mo. Nb and C contents are within the windows claimed by patent WO 03/025239, has an Rm equal to 795 MPa compared with 1300 MPa for the wire produced according to patent WO 03/025239. A comparison of the results obtained for counter-example 4, with an Rm equal to 794 MPa, with that of the publication by Nakama et al. (Metallogr. Microstruct. Anal. 2 (2013) 383-387), with an Rm of 1010 MPa after cold transformation steps, confirms this contribution of the transformation to the hardening.

It emerges that for an equivalent transformation range, the alloy reinforcement strategy with an Ni content of between 38.0 and 42.0, an Nb content of between 4.750 and 5.500 and a C content of between 0.010 and 0.100 afforded the best compromise between hardening and low CTE.

TABLE 2

| | | Reference | Counter- | Counter- | Counter- | Counter- |
|---|---|---|---|---|---|---|
| | Example 1 | Invar 36 | example 1 | example 2 | example 3 | example 4 |
| Rm (MPa) | 1213 | 453 | | 871 | 795 | 794 |
| A5d % | 8 | 41 | | 5.5 | 10.5 | 12.5 |
| HV30 | 391 | 149 | 212 | 282 | 254 | 272 |
| CTE | 3.30 | 1.86 | | 2.72 | 3.50 | 2.05 |
| (×10⁻⁶/° C.) | | | | | | |

Example 1, in another test, was heat treated by dissolution at 1050° C., for 1 h followed by water cooling and then ageing at 600° C., for 5 h followed by air cooling, after forging. In this case, the Rm is equal to 1129 MPa, the elongation is 15.5%, the HV30 hardness measured according to the standard ISO 6507-1:2018 is 378 HV and the CTE between 30° C., and 200° C., is 3.09×10⁻⁶/° C. The CTE was also measured on this sample between 30° C., and 100° C., between 30° C., and 300° C., and between 30° C., and 400° C. The results obtained are 2.47×10⁻⁶/° C., 5, 16×106/° C., and 7.49×10-6/° C., respectively. Thus, the CTE remains low even for a temperature range of 30° C., to 400° C.

Table 3 shows the composition of an example 2 of an iron-based alloy for a metal part according to the present invention and a counter-example 5 reinforced by the precipitation of vanadium carbides produced under vacuum and then gas atomized in powder form and screened, formed into shape via the additive manufacturing process of laser melting on a powder bed with a layer thickness of 50 μm and a lasering strategy at +45° (i.e. a rotation of 90° between each successive layer), then heat treated at 1050° C., for 1 h followed by air cooling, then aged at 600° C., for 5 h followed by air cooling for Example 2 and at 650° C., for 5 h followed by air cooling for counter-example 5.

TABLE 3

| Elements | Example 2 | Counter-example 5 |
|---|---|---|
| Fe + impurities | remainder | remainder |
| Ni | 41.0 ± 0.5 | 34.5 ± 0.5 |
| Co | <0.400 | <0.5 |
| Cr | 0.016 ± 0.0015 | <0.01 |
| Nb | 5.250 ± 0.007 | — |
| V | — | 1.38 ± 0.007 |
| Mo | — | — |
| C | 0.0176 ± 0.0015 | 0.2336 ± 0.0022 |
| N | 0.0085 ± 0.0010 | 0.0066 ± 0.0009 |
| O | 0.029 ± 0.0017 | 0.0187 ± 0.0019 |
| Mn | 0.352 ± 0.009 | 0.382 ± 0.005 |
| Si | 0.340 ± 0.0063 | 0.33 ± 0.007 |
| S | 0.00154 ± 0.0001 | 0.0021 ± 0.0001 |
| P | <0.0050 | <0.005 |

Table 4 shows the Vickers HV30 hardnesses obtained for Example 2 and Counter-example 5 after production of parts via the process of laser melting on a powder bed and the heat treatment indicated above.

TABLE 4

| | Example 2 | Counter-example 5 |
|---|---|---|
| HV30 | 418 | 266 |

Example 2 of an alloy according to the invention, produced by powder processing and additive manufacturing, confirms the level of hardness obtained for Example 1 by the forging process. Counter-example 5 confirms that the hardening achieved by reinforcement by precipitation of vanadium carbides does not allow such a high level of hardness to be obtained.

Table 5 shows the tensile strengths Rm and elongations at break A % obtained after various heat treatments performed on a metal part based on the alloy of Example 2. The index “H” corresponds to a test performed on a test specimen manufactured horizontally, while the index “V” corresponds to a test performed on a test specimen manufactured vertically. It can be seen that it is possible to modulate the heat treatment to obtain a metal part by favouring its hardness or its elongation at break.

TABLE 5

| | Rm (MPa) | A % (%) | Heat Treatment |
|---|---|---|---|
| Ex. 2-1H | 935 | 11.2 | 600° C./10 h air |
| Ex. 2-1V | 844 | 11.2 | |
| Ex. 2-2H | 751 | 19.5 | dissolution treatment 950° C./1 h air |
| Ex. 2-2V | 683 | 21.7 | then ageing 600° C./5 h air |
| Ex. 2-3H | 765 | 19.8 | 950° C./30 min air then |
| Ex. 2-3V | 698 | 21 | ageing 600° C./5 h air |

1.-13. (canceled)

14. A metal part for manufacturing rubber articles based on an iron-based alloy composition comprising, in percentages by weight of the total composition:
nickel: 38.0-42.0, advantageously 39.0-42.0;
niobium: 4.750-5.500, advantageously 5.000-5.500;
carbon: 0.010-0.100, advantageously 0.015-0.070;
cobalt: ≤0.400, advantageously≤0.100;
chromium: ≤0.500;
silicon: ≤0.500;
manganese: ≤0.500;
iron: remainder; and
impurities,
wherein at least one of the following conditions of percentage content by weight of the total composition is met:
nitrogen≤0.030% by weight of the total composition;
oxygen≤0.040% by weight of the total composition;
hydrogen≤0.0050% by weight of the total composition;
sulfur≤0.0150% by weight of the total composition;
phosphorus≤0.0150% by weight of the total composition;
aluminium≤0.100% by weight of the total composition;
titanium≤0.100% by weight of the total composition;
vanadium≤0.100% by weight of the total composition;
molybdenum≤0.020% by weight of the total composition;
calcium≤0.015% by weight of the total composition;
copper≤0.010% by weight of the total composition; and
magnesium≤0.015% by weight of the total composition.

15. The metal part according to claim 14, wherein the iron-based alloy comprises not more than 1.00% by weight of impurities.

16. The metal part according to claim 14, wherein the iron-based alloy comprises not more than 0.050% by weight of cobalt relative to the total weight of the composition.

17. The metal part according to claim 14, wherein the metal part is selected from curing molds, injection molds and constituent elements of curing and injection molds.

18. A process for manufacturing the metal part according to claim 14, the process comprising the following steps:
(A) manufacturing an iron-based alloy powder having the composition of the iron-based alloy composition on which the metal part is based, according to the following steps:
(a) mixing elementary or pre-alloyed starting materials;
(b) melting the mixture obtained in step (a);
(c) gas atomizing a product obtained in step (b) so as to obtain a powder;
(d) screening or sieving the powder obtained in step (c) so as to obtain a desired particle size fraction; and
(e) recovering the powder obtained;
(B1) subjecting the powder obtained in step (A) to an additive manufacturing process to obtain a metal part; or
(B2) subjecting the powder obtained in step (A) to a laser melting process by powder spraying, followed by forging of a deposit formed from the melted powder to obtain a metal part;
(C) subjecting the metal part obtained in step (B1) or (B2) to at least one thermal and/or physical and/or chemical treatment; and
(D) recovering the metal part thus obtained.

19. The process according to claim 18, wherein step (B1) is selective laser melting on a powder bed.

20. The process according to claim 18, wherein step (C) consists of a dissolution treatment between 1050° C., and 1150° C., for 1 hour to 4 hours followed by an ageing treatment between 600° C., and 700° C., for 5 hours to 10 hours, or a direct ageing treatment between 600° C., and 700° C., for 5 hours to 10 hours without dissolution.

21. The process according to claim 18, wherein step (C) consists of a dissolution treatment between 900° C., and 1000° C., for 30 min to 1 hour, followed by an ageing treatment between 600° C., and 700° C., for 5 hours to 10 hours.

22. A process for manufacturing the metal part according to claim 14, the process comprising the following steps:
(i) mixing elementary or pre-alloyed starting materials;
(ii) melting the mixture obtained in step (i);
(iii) optionally, homogenizing by heat treatment of an ingot obtained in step (ii);
(iv) transforming the ingot obtained in either of steps (ii) and (iii) by forging; and
(v) recovering the metal part thus obtained.

23. The process according to claim 22, further comprising step (vi) subjecting the metal part obtained in step (v) to a dissolution treatment between 1050° C., and 1150° C., for 1 hour to 4 hours followed by an ageing treatment between 600° C., and 700° C., for 5 hours to 10 hours, or a direct ageing treatment between 600° C., and 700° C., for 5 hours to 10 hours without dissolution.

24. The process according to claim 22, further comprising step (vi) subjecting the metal part obtained in step (v) to a dissolution treatment between 900° C., and 1000° C., for 30 min to 1 hour, followed by an ageing treatment between 600° C., and 700° C., for 5 hours to 10 hours.

25. The metal part according to claim 14, wherein the metal part has a coefficient of linear expansion of less than 3.5×10⁻⁶/° C. between 30° C., and 200° C., according to standard ASTM E228-17 (2017), and/or
the metal part has a tensile strength of greater than 1000 MPa according to standard ISO 6892-1:2019, and/or
the metal part has a hardness HV30 of greater than 350 HV according to standard ISO 6507-1:2018.
